(19) United States
(12) Patent Application Publication
(10) Pub. No.: US 2026/0229758 A1
(43) Pub. Date: Aug. 6, 2026

(54) A BROADBAND TUNABLE WAVEGUIDE FILTER ARRANGEMENT

(71) Applicant: Telefonaktiebolaget LM Ericsson (publ), Stockholm (SE)

(72) Inventors: Jan SANDBERG, Frillesås (SE); Anatoli DELENIV, Mölndal (SE); Daniel SJÖBERG, Mölndal (SE)

(73) Assignee: Telefonaktiebolaget LM Ericsson (publ), Stockholm (SE)

(21) Appl. No.: 19/153,166

(22) PCT Filed: Feb. 6, 2023
(86) PCT No.: PCT/SE2023/050096

§ 371 Date: Aug. 1, 2025

(51) Int. Cl. H01P 1/208; H01P 3/12; H01P 11/00

(52) U.S. Cl. CPC H01P 1/208; H01P 3/12; H01P 11/002

(57) ABSTRACT

The present disclosure relates to a tunable waveguide filter arrangement (110) comprising a first filter port (111), a second filter port (112) and a plurality of cavities (113, 114, 115, 116) that are positioned between the first filter port (111) and the second filter port (112). The cavities are electrically interconnected by being arranged in a partly interleaved manner such that overlaps form iris openings (117, 118, 119) between the cavities (113, 114, 115, 116). The tunable waveguide filter arrangement (110) comprises a dielectric element (120, 121, 122, 123) for each cavity (113, 114, 115, 116), extending a certain adjustable protrusion distance (P) along its longitudinal extension (L) from a waveguide top (124) towards a waveguide bottom (125). A longitudinal center (L) of each dielectric element (120, 121, 122, 123) is positioned at a certain closest distance (d1, d2, d3, d4, d5, d6) from at least one adjacent iris opening (117, 118, 119).

### TECHNICAL FIELD

The present disclosure relates to a tunable waveguide filter arrangement comprising a first filter port, a second filter port and a plurality of cavities that are positioned between the first filter port and the second filter port.

### BACKGROUND

Despite quite impressive progress demonstrated in the last few decades in the microwave engineering area, the important role of waveguide components remains undisputed, this is due to their low loss and high-power capability performance.

In wireless communication networks, there are communication nodes, for example microwave link nodes. Microwave link nodes normally comprise microwave link antenna devices, where a microwave link antenna arrangement normally is connected to a radio branch for transmission, a transmission branch, via the antenna device, and a radio branch for reception, a reception branch, via the antenna device.

A microwave link antenna device is usually connected to a transmission branch and a reception branch via a diplexer arrangement that comprises a first band-pass filter that is connected to the reception branch and a second band-pass filter that is connected to the transmission branch. these filters are normally in the form of tunable waveguide filter where a three-port junction connects the transmit and receive branches to the antenna device, normally via a circulator or a similar device.

Since microwave links are manufactured and sold for many different frequency bands, and frequency sub-bands, it is necessary to have one specific diplexer per frequency band and frequency sub-band due to the frequency dependency of components.

Furthermore, not only diplexers require waveguide filters, but they can be used for many other applications, and the above problems apply for separate waveguide filters.

There is thus a desire to provide a tunable waveguide filter arrangement that can be used for more different frequency bands, and frequency sub-bands, than previously known.

### SUMMARY

The object of the present disclosure is to provide a tunable waveguide filter arrangement that can be used for more different frequency bands, and frequency sub-bands, than previously known.

This object is obtained by means of a tunable waveguide filter arrangement comprising a first filter port, a second filter port and a plurality of cavities that are positioned between the first filter port and the second filter port and are electrically interconnected by being arranged in a partly interleaved manner such that overlaps form iris openings between the cavities. The tunable waveguide filter arrangement comprises a dielectric element for each cavity, extending a certain adjustable protrusion distance along its longitudinal extension from a waveguide top towards a waveguide bottom. A longitudinal center of each dielectric element is positioned at a certain closest distance from at least one adjacent iris opening.

In this manner, a waveguide filter arrangement is formed that is compact and that allows the closest distance between the longitudinal center of each dielectric element and at least one adjacent iris opening to be chosen freely. This means that in the case of two adjacent iris openings can be positioned such that the corresponding closest distances can be chosen independently of each other. Increasing one of the closest distances does not mean that the other closest distance has to be decreased.

According to some aspects, the cavities form a zig-zag pattern. This increases the compact design.

According to some aspects, the cavities are connected to the filter ports via at least one corresponding waveguide transmission line. According to some further aspects, at least one cavity is arranged in a partly interleaved manner with a corresponding waveguide transmission line such that overlaps form waveguide connecting iris openings between the said cavities and said waveguide transmission line. The longitudinal center of each closest dielectric element is positioned at a certain closest waveguide distance from an adjacent waveguide connecting iris opening. In this manner, the waveguide filter arrangement is easily connected to further waveguide components.

According to some aspects, each closest distance runs between the longitudinal center of a corresponding dielectric element and a longitudinal center of a corresponding iris opening. According to some further aspects, the longitudinal centers run parallel to each other.

According to some aspects, the longitudinal center of each dielectric element coincides with the corresponding longitudinal extension of each dielectric element. This means that the dielectric elements at least partly extend along the electric field in the cavity.

According to some aspects, the dielectric elements are made in a plastic material or in a quartz material. These materials result in that there is an area of stronger electric field and magnetic field around the dielectric elements.

According to some aspects, the dielectric elements are in the form of dielectric screws, where rotation of the dielectric screws causes the dielectric screws to move along the corresponding longitudinal extension. This enables an easily performed and at the same time accurate and reliable adjustment of the dielectric elements.

According to some aspects, the iris openings between the cavities comprises separate iris parts. According to some further aspects, the iris openings between the cavities are formed by the overlaps only, the size of each overlap determining the size of each iris opening. According to some further aspects, each iris opening has the same height as the cavities.

This means that the iris openings can be formed in many ways, and that no separate iris parts are needed.

This object is also obtained by means of methods associated with the above advantages.

### BRIEF DESCRIPTION OF THE DRAWINGS

The present disclosure will now be described more in detail with reference to the appended drawings, where:

FIG. 1 shows a simplified top view of a diplexer;

FIG. 2 shows a schematic illustration of the diplexer.

FIG. 3 shows a simplified top view of a waveguide filer arrangement;

FIG. 4 shows an enlarged part of FIG. 3,

FIG. 5 shows a section view of FIG. 3;

FIG. 6 shows an example of filter characteristics;

FIG. 7 shows a cut-open view of three adjacent cavities; and

FIG. 8 shows a flowchart for methods according to the present disclosure.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

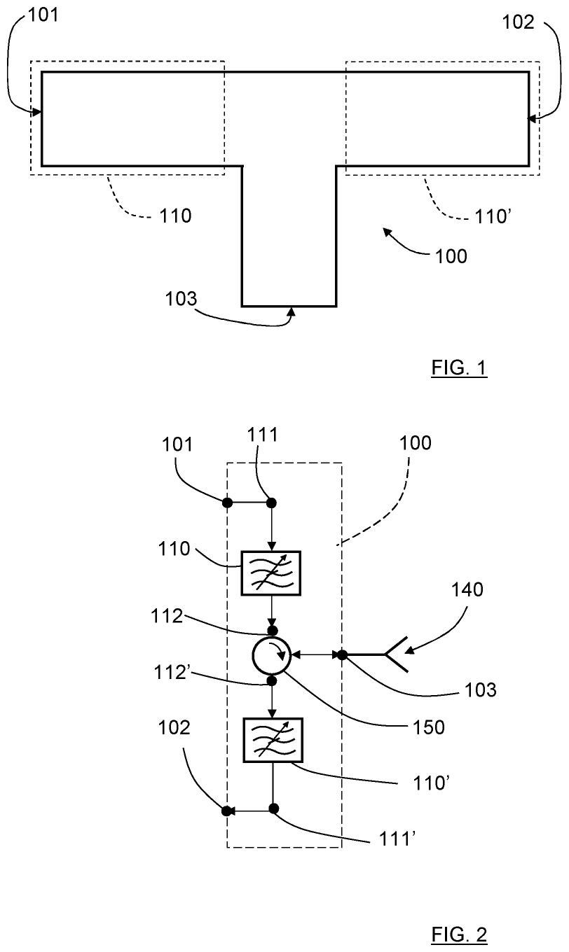

With reference to FIG. 1 and FIG. 2, there is a diplexer filter arrangement 100 comprising a first tunable waveguide filter arrangement 110 and a second tunable waveguide filter arrangement 110′. One first filter port 111 constitutes a diplexer Tx port 101 and another first filter port 111′ constitutes a diplexer Rx port 102, and the second filter ports 112, 112′ are connected to a diplexer common port 103. The diplexer common port 103 may for example be connected to an antenna arrangement 140.

In the following, the first tunable waveguide filter arrangement 110 will be described more in detail, and it should be understood that the second tunable waveguide filter arrangement 110′ is similar to the first tunable waveguide filter arrangement 110, being of the same type and having the same general configuration.

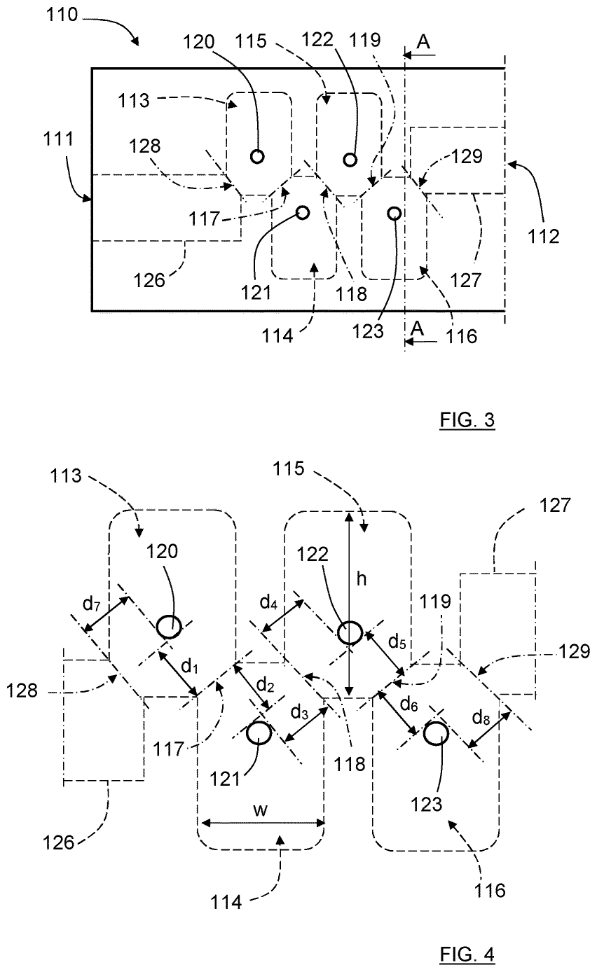

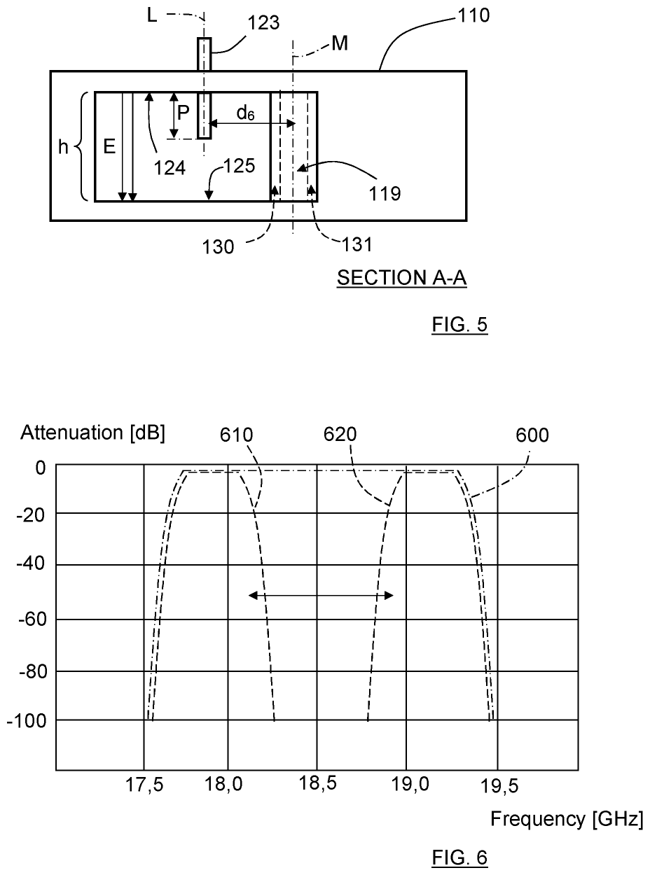

With reference to FIG. 3 that shows a top view of the tunable waveguide filter arrangement 110, FIG. 4 that shows a detail of FIG. 3 and FIG. 5 that shows a section of FIG. 3, the tunable waveguide filter arrangement 110 comprises a first filter port 111, a second filter port 112 and a plurality of cavities 113, 114, 115, 116 that are positioned between the first filter port 111 and the second filter port 112 and are electrically interconnected by being arranged in a partly interleaved manner such that overlaps form iris openings 117, 118, 119 between the cavities 113, 114, 115, 116. According to some aspects, the cavities 113, 114, 115, 116 form a zig-zag pattern, for example by corners of adjacent cavities being overlapping. This increases the compact design.

Furthermore, the tunable waveguide filter arrangement 110 comprises a dielectric element 120, 121, 122, 123 for each cavity 113, 114, 115, 116, extending a certain adjustable protrusion distance P along its longitudinal extension L from a waveguide top 124 towards a waveguide bottom 125, a longitudinal center L of each dielectric element 120, 121, 122, 123 being positioned at a certain closest distance d₁, d₂, d₃, d₄, d₅, do from at least one adjacent iris opening 117, 118, 119.

In this example, the longitudinal center L of each dielectric element 120, 121, 122, 123 coincides with the corresponding longitudinal extension L of each dielectric element 120, 121, 122, 123. According to some aspects, as indicated in FIG. 5, each closest distance d₁, d₂, d₃, d₄, d₅, d₆ runs between the longitudinal center L of a corresponding dielectric element 120, 121, 122, 123 and a longitudinal center M of a corresponding iris opening 117, 118, 119. According to some further aspects, the longitudinal centers L, M run parallel to each other. This means that the dielectric elements at least partly extend along the electric field E in the cavity.

In this example, there is a first cavity 113, a second cavity 114, a third cavity 115 and a fourth cavity 116, each cavity 113, 114, 115, 116 having a corresponding first dielectric element 120, second dielectric element 121, third dielectric element 122, and fourth dielectric element 123. The first cavity 113 and the second cavity 114 are interconnected by means of a first iris opening 117, the second cavity 114 and the third cavity 115 are interconnected by means of a second iris opening 118, and the third cavity 115 and the fourth cavity 116 are interconnected by means of a third iris opening 119.

In this example, there is further a first closest distance d1 between the first dielectric element 120 and the first iris opening 117, a second closest distance d₂ between the second dielectric element 121 and the first iris opening 117, a third closest distance d₃ between the second dielectric element 121 and the second iris opening 118, a fourth closest distance d4 between the third dielectric element 122 and the second iris opening 118, a fifth closest distance ds between the third dielectric element 122 and the third iris opening 119, and a sixth closest distance do between the fourth dielectric element 123 and the third iris opening 119. This is of course only an example, there may be any suitable number of cavities with corresponding dielectric elements and iris openings. The closest distances d₁, d₂, d₃, d₄, d₅, do do not have to be equal or correlated, but are chosen during filter design to achieve optimal performance.

In this manner, a compact waveguide filter arrangement 110 is formed that is compact and that allows the closest distance d₁, d₂, d₃, d₄, d₅, do between the longitudinal center L of each dielectric element 120, 121, 122, 123 and at least one adjacent iris opening 117, 118, 119 to be chosen freely. This means that in the case of two adjacent iris openings 117, 118, for example for a second cavity 114, the corresponding dielectric element 121 can be positioned such that the corresponding closest distances d₂, d₃ can be chosen independently of each other. Increasing one of the closest distances d₂, d₃ does not mean that the other closest distance has to be decreased since there are no requirements regarding symmetry for the position of the dielectric elements 120, 121, 122, 123 in the corresponding cavities 113, 114, 115, 116, only synchronous tuning may according to some aspects be used as suggested below. These closest distances are chosen when the waveguide filter arrangement 110 is designed.

The tunable waveguide filter arrangement 110 is tuned by adjusting the adjustable protrusion distance P by moving the dielectric elements 120, 121, 122, 123 along their longitudinal extensions. The tunable waveguide filter arrangement 110 furthermore enables an adjustable frequency band over a relatively large bandwidth, at least a bandwidth of 10% of a filter center frequency. A filter function normally deteriorates due to dispersion of coupling at the input and between a filter's cavities. As a center frequency of a filter is tuned down, each coupling gets weaker and not in a synchronized manner. To achieve the constant bandwidth of tunable filter all the couplings should be preserved irrelevant to the center frequency of the filter, and this is enabled by means or the present tunable waveguide filter arrangement 110.

This is illustrated in FIG. 6, showing an example of filter characteristics, where a filter band 610, 620 is tunable, as indicated with an arrow, within a relatively large filter band 600. FIG. 6 is only to be regarded as a schematic illustration of a typical performance for the waveguide filter arrangement 110, not as an actual measurement or simulation.

The dielectric elements 120, 121, 122, 123 can according to some aspects be constituted by dielectric tuning screws, or any other type of cylindrical objects that can be moved along the corresponding longitudinal extension L for tuning of the waveguide filter arrangement 110.

According to some aspects, the dielectric elements 120, 121, 122, 123 are made in a plastic material or in a quartz material. Using these materials results in that there is an area of stronger electric field around the dielectric elements 120, 121, 122, 123, and since the electric and magnetic fields are interconnected through Maxwells equations, a stronger electric field results in a stronger magnetic field around the dielectric elements 120, 121, 122, 123.

With properly chosen closest distance d₁, d₂, d₃, d₄, d₅, do between the longitudinal center L of each dielectric element 120, 121, 122, 123 and at least one adjacent iris opening 117, 118, 119, the effect of dispersion, which leads to weaker coupling for lower frequencies, is compensated by stronger magnetic field due to partially inserted dielectric elements 120, 121, 122, 123.

According to some aspects, each iris opening has the same height h as the cavities 113, 114, 115, 116 as indicated in FIG. 5. In this way, constant inter-cavity coupling can be achieved in full tuning range.

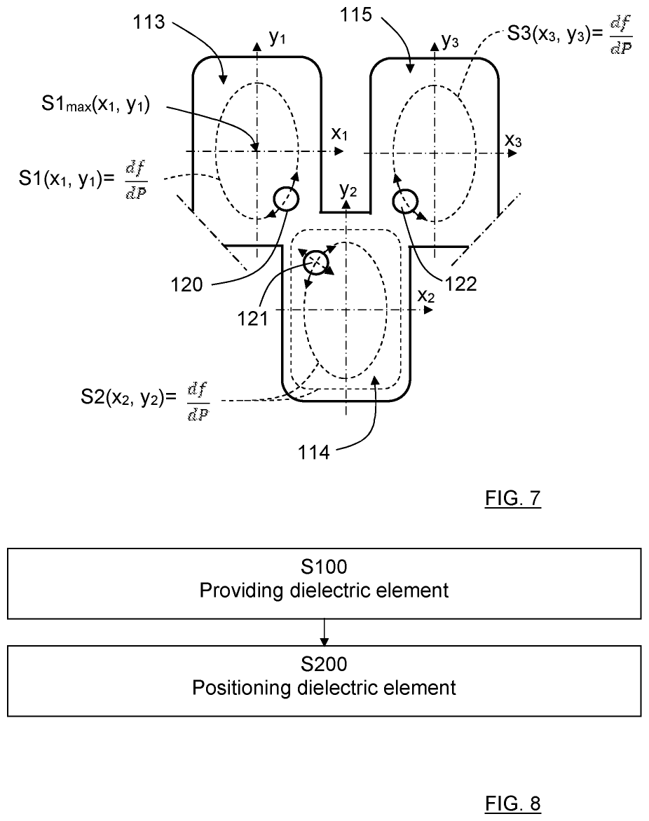

According to some aspects, as indicated in FIG. 7 that shows a cut-open view of three adjacent cavities 113, 114, 115, every cavity within the filter arrangement should be synchronously tuned. This requires precise placement of the dielectric elements 120, 121, 122 within each corresponding cavity 113, 114, 115 such that their frequency sensitivity,

$$\frac{df}{dP} [ Hz / mm ] ,$$

is matched according to S₁(X₁, y₁)=S₂(X₂, y₂)=S₃(X₃, y₃) where f is the frequency, S is the sensitivity and P is the certain adjustable protrusion distance P indicated in FIG. 5. While maximum sensitivity for a dominant mode, Sₘₐₓ, is always in the middle of cavity as indicated for the first cavity 113, equal sensitivity locus Sₙ(Xₙ, Yₙ)=Const<Sₘₐₓ has a shape of deformed circle, where n denotes a certain dielectric element. In this example, n=1 corresponds to the first dielectric element 120, n=2 corresponds to the second dielectric element 121 and n=3 corresponds to the third dielectric element 122.

As a dielectric element gets closer to the respective cavity inner wall, the sensitivity reduces and the respective locus gradually transforms into a rectangle as indicated for the dielectric element 121 of the second cavity 114. Moving a dielectric element 120, 121, 122 along such a deformed circle/locus toward a certain iris opening allows a desired level of compensation of dispersion in the iris opening in question to be obtained. A stronger compensation requires use of circle/locus closer to the iris opening in question.

According to some aspects, the cavities 113, 114, 115, 116 are connected to the filter ports 111, 112 via at least one corresponding waveguide transmission line 126, 127. According to some further aspects, at least one cavity 113, 116 is arranged in a partly interleaved manner with a corresponding waveguide transmission line 126, 127 such that overlaps form waveguide connecting iris openings 128, 129 between the said cavities 113, 116 and said waveguide transmission line 126, 127. The longitudinal center L of each closest dielectric element 120, 123 is positioned at a certain closest waveguide distance d₇, d₈ from an adjacent waveguide connecting iris opening 128, 129.

For example, corners of adjacent cavities 113, 116 and waveguide transmission lines 126, 127 are overlapping, such that the zig-zag pattern mentioned previously is continued as shown in FIG. 3 and FIG. 4. The closest waveguide distances d₇, d₈ are according to some aspects measured in the same way as the previously discussed closest distances d₁, d₂, d₃, d₄, d₅, d₆. According to some aspects, the waveguide connecting iris openings 128, 129 have size that differs from the size of the previously discussed iris openings 117, 118, 119. In fact, no iris openings 117, 118, 119, 128, 129 need to be equal, the shape and sizes of the iris openings 117, 118, 119, 128, 129 being determined during filter design to achieve optimal filter performance.

There is a seventh closest distance d₇ between the first dielectric element 120 and a first waveguide connecting iris opening 128, connecting the first cavity 113 to a first waveguide transmission line 126, and am eighth closest distance de between the fourth dielectric element 123 and a second waveguide connecting iris opening 129, connecting the fourth cavity 116 to a second waveguide transmission line 127.

In this manner, the waveguide filter arrangement 110 is easily connected to further waveguide components.

According to some aspects, the dielectric elements 120, 121, 122, 123 are in the form of dielectric screws 120, 121, 122, 123, where rotation of the dielectric screws 120, 121, 122, 123 causes the dielectric screws 120, 121, 122, 123 to move along the corresponding longitudinal extension L. This enables an easily performed and at the same time accurate and reliable adjustment of the dielectric elements 120, 121, 122, 123.

According to some aspects, the iris openings 117, 118, 119 between the cavities 113, 114, 115, 116 comprise separate iris parts 130, 131. According to some aspects, these iris parts 130, 13 may be inclined or have any suitable shape, forming the shape of the corresponding iris opening. According to some aspects, the iris openings 117, 118, 119 between the cavities 113, 114, 115, 116 are formed by the overlaps only, the size of each overlap determining the size of each iris opening. This means that the iris openings can be formed in many ways, and that no separate iris parts are needed.

The present disclosure also relates to the diplexer filter arrangement 100 as mentioned initially. According to some aspects, with reference to FIG. 2, the second filter ports 111, 111′ are connected to a diplexer common port via a circulator 150.

With reference to FIG. 8, the present disclosure also relates to a method of configuring a tunable waveguide filter arrangement 110 comprising a first filter port 111, a second filter port 112 and a plurality of cavities 113, 114, 115, 116 that are positioned between the first filter port 111 and the second filter port 112 and are electrically interconnected by being arranged in a partly interleaved manner such that overlaps form iris openings 117, 118, 119 between the cavities 113, 114, 115, 116. The method comprises providing S100 a dielectric element 120, 121, 122, 123 for each cavity 113, 114, 115, 116, extending a certain adjustable protrusion distance P along its longitudinal extension L from a waveguide top 124 towards a waveguide bottom 125, and positioning S200 a longitudinal center L of each dielectric element 120, 121, 122, 123 at a certain closest distance d₁, d₂, d₃, d₄, d₅, do from at least one adjacent iris opening 117, 118, 119.

The present disclosure is not limited to the examples above, but may vary freely within the scope of the appended claims. For example, the waveguide parts may be made in any suitable material such as aluminum or plastics covered with an electrically conducting layer.

1. A tunable waveguide filter arrangement comprising a first filter port, a second filter port and a plurality of cavities that are positioned between the first filter port and the second filter port and are electrically interconnected by being arranged in a partly interleaved manner such that overlaps form iris openings between the cavities, wherein the tunable waveguide filter arrangement comprises a dielectric element for each cavity, extending a certain adjustable protrusion distance (P) along its longitudinal extension (L) from a waveguide top towards a waveguide bottom, a longitudinal center (L) of each dielectric element being positioned at a certain closest distance from at least one adjacent iris opening.

2. The tunable waveguide filter arrangement according to claim 1, wherein the cavities form a zig-zag pattern.

3. The tunable waveguide filter arrangement according to claim 1, wherein the cavities are connected to the filter ports via at least one corresponding waveguide transmission line.

4. The tunable waveguide filter arrangement according to claim 3, wherein at least one cavity is arranged in a partly interleaved manner with a corresponding waveguide transmission line such that overlaps form waveguide connecting iris openings between the said cavities and said waveguide transmission line, the longitudinal center (L) of each closest dielectric element being positioned at a certain closest waveguide distance from an adjacent waveguide connecting iris opening.

5. The tunable waveguide filter arrangement according to claim 1, wherein each closest distance runs between the longitudinal center (L) of a corresponding dielectric element and a longitudinal center (M) of a corresponding iris opening.

6. The tunable waveguide filter arrangement according to claim 5, wherein the longitudinal centers (L, M) run parallel to each other.

7. The tunable waveguide filter arrangement according to claim 1, wherein the longitudinal center (L) of each dielectric element coincides with the corresponding longitudinal extension (L) of each dielectric element.

8. The tunable waveguide filter arrangement according to claim 1, wherein the dielectric elements are made in a plastic material or in a quartz material.

9. The tunable waveguide filter arrangement according to claim 1, wherein the dielectric elements are in the form of dielectric screws, where rotation of the dielectric screws causes the dielectric screws to move along the corresponding longitudinal extension (L).

10. The tunable waveguide filter arrangement according to claim 1, wherein the iris openings between the cavities comprise separate iris parts.

11. The tunable waveguide filter arrangement according to claim 1, wherein the iris openings between the cavities are formed by the overlaps only, the size of each overlap determining the size of each iris opening.

12. The tunable waveguide filter arrangement according to claim 1, wherein each iris opening has the same height (h) as the cavities.

13. A diplexer filter arrangement comprising first second tunable waveguide filter arrangements according to claim 1, one first filter port constituting a diplexer Tx port and another first filter port constituting a diplexer Rx port, and the second filter ports being connected to a diplexer common port.

14. The diplexer filter arrangement according to claim 13, wherein the second filter ports are connected to a diplexer common port via a circulator.

15. A method of configuring a tunable waveguide filter arrangement comprising a first filter port, a second filter port and a plurality of cavities that are positioned between the first filter port and the second filter port and are electrically interconnected by being arranged in a partly interleaved manner such that overlaps form iris openings between the cavities, wherein the method comprises
providing a dielectric element for each cavity, extending a certain adjustable protrusion distance (P) along its longitudinal extension (L) from a waveguide top towards a waveguide bottom, and
positioning a longitudinal center (L) of each dielectric element at a certain closest distance from at least one adjacent iris opening.
